(19) United States
(12) Patent Application Publication
(10) Pub. No.: US 2016/0048646 A1
(43) Pub. Date: Feb. 18, 2016

(54) INTEGRATED HEALTH SAVINGS ACCOUNT METHODS AND SYSTEMS

(71) Applicant: Xerox Corporation, Norwalk, CT (US)

(72) Inventors: Dennis STOVER, Pittsburgh, PA (US); Elijah ADAMS, Pittsburgh, PA (US); Katherine KLUG, Spring Valley, WI (US); Ken KUBALA, Pittsburgh, PA (US); Darren BAER, Cherry Hill, NJ (US)

(21) Appl. No.: 14/925,417

(22) Filed: Oct. 28, 2015

Related U.S. Application Data
(63) Continuation of application No. 11/078,903, filed on Mar. 11, 2005, now abandoned.
(60) Provisional application No. 60/552,621, filed on Mar. 11, 2004.

(51) Int. Cl. G06F 19/00; G06Q 40/06

(52) U.S. Cl. CPC G06F 19/328; G06Q 40/06

(57) ABSTRACT

An integrated health savings account system which provides electronic (real-time or batch) interconnection between a health plan claims administrator and an individual healthcare spending account. An accountholder presents an identification card to a healthcare provider or pharmacy in order to receive treatment or obtain prescription drugs. A claim for reimbursement of healthcare expenses is sent to a health plan claims administrator (healthcare) or a pharmacy benefits manager (prescription drugs) for adjudication and determination of any deductibles. The adjudicated claim is sent to an individual healthcare spending account custodian/trustee for automatic determination of whether the remaining funds in the accountholder's individual healthcare spending account can cover the proposed claim. An indication of whether the amount of funds can cover the claim (in whole or in part) is transmitted back to the claims administrator or pharmacy benefits manager, and, if requested, the actual funds are transmitted in real-time or as part of a batch process. The individual healthcare spending account may be integrated with an investment account whereby an accountholder may invest excess funds (i.e., over a predefined minimum balance), for example, in mutual funds.

### CLAIM OF PRIORITY

This invention claims the benefit of the earlier filing date of U.S. Provisional Patent Application No. 60/552,621 which was filed on Mar. 11, 2004.

### BACKGROUND OF THE INVENTION

1. Field of the Invention

The present invention relates generally to systems and methods for integrating individual healthcare spending accounts with an insurance company claims process, and, more specifically, the present invention provides an electronic connection between a healthcare provider (e.g., healthcare claims administrator, pharmacy benefits manager, etc.) and a health savings account or dual health savings account tied to an investment account.

2. Description of the Background

The technological fields of payment for various healthcare related services and general banking and investments have overlapped throughout recent history in myriad ways. As government regulations have loosened and allowed additional accountholder functionality, efforts have been made to design and implement financial systems which increase the efficiency and decrease the complexity of these healthcare-related financial tasks. The present invention relates to a next-generation financial system which integrates an individual healthcare spending account (such as an interest bearing checking/debit card account) with the claims processing systems used to electronically process, adjudicate and re-price claims for healthcare. The present invention preferably also includes integration with investment accounts.

There are many different types of individual healthcare spending accounts allowed by the government and available for use by accountholders. Traditionally, many of these accounts (such as a Flexible Spending Account) were unfunded accounts that aggregated monies for health care expenses of all members of a group (e.g., all employees of a common employer). The plan administrator would manage the payment of claims for qualified medical services by aggregating all of the claims and making payment from the entire pool of funds. More recently, funded individual accounts have been mandated for healthcare spending. These accounts are owned by an individual accountholder and actually include a balance in real dollars. The accounts are also portable, where the accountholder retains the assets upon leaving the employer. The management of these individual accounts is more complicated than unfunded accounts because the dollar value and transactions of each account must be maintained separately—with no aggregation.

One early type of individual healthcare spending account was known as a Flexible Spending Account (FSA). Flexible Spending Accounts were authorized by the Internal Revenue Service (IRS Section 125) as a way for accountholders (e.g., covered individuals or employees) to pay out-of-pocket qualified medical expenses and dependent care expenses on a pre-tax basis.

Generally speaking, FSA payments are made from amounts deducted from an employee's paycheck and are exempt from federal income tax, state income tax and social security tax. These contributions are deducted from the employee's paycheck before taxes are calculated. Moreover, no taxes are paid when FSA funds are used to reimburse the accountholder for qualified expenses. Overall, these aspects of FSAs reduce the employee's taxable income reported on their W-2 form and also reduce the amount of payroll tax that the employer must pay. Traditionally, an FSA is an unfunded account and the amounts deducted from the employee's paycheck are held as part of the employer's general assets until needed to pay a claim—in effect aggregating all of the employees' funds together.

FSA accountholders can use their pre-tax dollars to pay for unreimbursed health-care expenses. Employees may also direct some of their FSA contributions to cover dependent care costs, such as daycare bills for their children or adult care expenses for aged parents.

To efficiently deal with FSAs, computer systems and methods were developed to streamline the process of making payments from an FSA. The systems were directed to ensuring that FSA funds were only used to reimburse for qualified expenses (to avoid IRS penalties). For example, U.S. patent application Ser. No. 09/776,524 filed on Feb. 2, 2001, which is expressly incorporated by reference in its entirety, dealt with the use of shadow accounts to ensure that an FSA was not debited until it was confirmed that the proposed charge was for a qualified expense. Although this FSA-based system was a good first step toward integrating certain healthcare payment and banking functions, additional systems were sought as these (and other individual healthcare spending accounts) became funded—a different problem entirely.

After the IRS allowed the use of FSAs to pay for qualified expenses, the Medicare Prescription Drug Improvement and Modernization Act of 2003 permitted the establishment of Health Savings Accounts (HSAs). An eligible individual can establish an HSA with a qualified HSA trustee or custodian. Any insurance company or bank (including a similar financial institution as defined in Section 408(n) of the Internal Revenue Code) can be an HSA trustee or custodian.

The HSA is a type of individual healthcare spending account that is characterized by a funded individual consumer-owned trust or custodial account established for the purpose of paying qualified medical expenses in conjunction with a consumer driven, high deductible health plan. The HSA may be an interest-bearing account, and the accountholder's interest in the account balance is non-forfeitable (as opposed to FSAs which are unfunded, non-interest bearing and revert to employers if the yearly withholding is not spent). Upon death, the assets of the account can be transferred tax-free to a spouse. The assets of an HSA are also portable, and may be maintained or transferred to another HSA. However, unlike FSAs, the individual accountholder, not the employer, is responsible for ensuring that withdrawals from the HSA are for qualified medical expenses.

To utilize an HSA, the individual or family must be covered only by a “high deductible health plan”—a plan that imposes certain minimum deductible and maximum out-of-pocket limits for single and family coverage. The statute determines the actual dollar amounts of these limits, and these high deductible plans may have preventative care without a deductible.

Typically, there are also limits on deposits for HSAs, again defined by statute. Deposits by employers and employees via a Section 125 plan are in pre-tax dollars, but deposits by individuals are tax deductible. Additional contributions are allowed for those who are 55 years old (or older). The interest earned on HSAs accumulates tax free.

There are also limitations on withdrawals from HSAs. For example, withdrawals for qualified medical expenses shall not be included in gross income. However, withdrawals not used for qualified medical expenses are included in gross income and are subject to a penalty prior to Medicare age being reached. These and other statutory limitations and features of HSAs are subject to change, but it is expected that an HSA is a good candidate as an exemplary individual healthcare spending account for use as part of the present invention.

The already rapid growth in the number of insurance companies offering consumer driven plans is expected to accelerate because of the introduction of HSAs. For example, insurance companies (health plans) may change their programs from employer owned, notional Health Reimbursement Accounts (HRAs) to funded HSAs (or other funded individual healthcare spending accounts) that will give consumers a financial interest in using healthcare dollars wisely. The number of employers offering consumer driven healthcare plans should expand as HSAs (or similar accounts) provide: (1) opportunities for consumers to take a financial interest in reducing health plan costs; (2) opportunities for employers to mitigate rising healthcare costs; and (3) opportunities for employers to reduce their administrative burden.

On the other side, consumer acceptance of consumer driven healthcare should accelerate due to: (1) the financial incentives of retaining any healthcare cost savings; (2) the ability to grow the balances tax-free; and (3) the year-over-year rollover and portable nature of the accounts.

Consumer interest in HSAs (and similar funded healthcare spending accounts) should increase because the balances in the HSA can be expected to grow rapidly. For example, individuals can make additional deposits to their accounts to fund the gap between the employer's funding and the deductible of the individual's healthcare coverage. Further, some individuals will use after-tax dollars to pay for medical expenses and allow the HSA to grow as a tax-deferred investment that has better withdrawal features than an IRA. Finally, employers may simply offer these accounts instead of FSAs and HRAs. Therefore, there are many reasons to develop systems to facilitate the integration of HSAs (and other funded individual healthcare spending accounts) into the existing electronic claims processing systems used by providers/health plans.

The only real alternative to the present invention is the billing of individuals by healthcare providers, whereupon individuals may pay claims and submit requests for reimbursement. It is clear that, when compared to this alternative process, the present invention improves the speed of payment and relieves the individual from the need to make a payment as it is made automatically. The present invention also improves the efficiency with which health plans can track progress against deductibles and ensures that negotiated discounts are properly applied.

### SUMMARY OF THE INVENTION

In accordance with at least one preferred embodiment, the present invention provides integrated health savings account systems and methods with improved and expanded administration and payment solutions as well as options for account growth for many different types of funded individual healthcare spending accounts. Specifically, the present invention provides integration (in real-time or as part of a batch process) between the electronic claims processing systems already in use by insurance companies and providers with an individual's healthcare spending account. In this way, the invention includes methods and systems for tying health claim payments to individual owned and funded accounts.

The integrated health savings account system preferably allows for the deposit of funds into the individual healthcare spending account (such as an HSA) in a variety of ways, including, but not limited to:
Automated Clearinghouse (ACH) transactions which post directly to the individual healthcare spending account;
“lump” ACH transactions which post to a staging account and are then posted to individual healthcare spending accounts based on a separate data file created by the funding party;
“lump” wire transfers which post to a staging account and are then posted to individual healthcare spending accounts based on a separate data file created by the funding party;
“lump” check deposits which post to a staging account and are then posted to individual healthcare spending accounts based on a separate data file created by the funding party;
“lump” check deposits which post to a staging account and are then posted to individual healthcare spending accounts based on a separate listing created by the funding party; and o individual check deposits which post to individual healthcare spending accounts.

The present invention preferably provides an integrated connection between the healthcare claims processing system and the individual healthcare spending account (such as an HSA). In this way, at the time that a claim payment is requested, the individual healthcare spending account can be queried to determine the amount of available funds to prevent overdraft of the individual healthcare spending account and to process individual payment for a healthcare claim. The integrated health savings account system preferably includes functionality to adjudicate the incoming healthcare claim (i.e., the insurance company determines whether and how much to pay on the claim), determine accountholder deductible or other cost, and seamlessly pay the claim (directly by the trustee/custodian) for qualified expenses out of the individual's healthcare spending account.

In an optional embodiment, the present invention includes an investment account, such as for mutual funds, in which an accountholder may choose to put “excess” funds from an individual healthcare spending account for a given time period. Typically, these investment accounts are integrated with the individual healthcare spending account, require some minimum balance to remain in the individual healthcare spending account proper, and may not allow an accountholder to directly withdraw funds from the investment. Instead, the investment money is transferred to the individual healthcare spending account, where it again earns conventional interest and may be accessed by the accountholder, e.g., with a debit card, check or the health plan via direct billing integration.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows a high level diagram of an integrated health savings account system according to the present invention;

FIG. 2 is a flow chart showing a preferred enrollment process for an integrated health savings account system;

FIG. 3 shows a diagram of the major ways in which an individual healthcare spending account may be funded;

FIG. 4 is a flow chart of an exemplary medical claims workflow using direct billing;

FIG. 5 is a flow chart of an exemplary medical claims workflow using a debit card tied to the individual healthcare spending account;

FIG. 6 is a flow chart of an exemplary prescription drugs workflow using direct billing;

FIG. 7 is a flow chart of an exemplary prescription drugs workflow using a debit card tied to the individual healthcare spending account;

FIG. 8 is a flow chart of an exemplary debit card workflow;

FIG. 9 is a block diagram of check payment workflow; and

FIG. 10 is a high level block diagram of system flow for an integrated health savings account system.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

The present invention, in at least one preferred embodiment, provides an integrated health savings account system with improved and expanded payment solutions as well as competitive investment options. The present invention preferably facilitates individual healthcare spending account balance inquiry and payment processing integrated with claims adjudication by providing an electronic link (in real-time or as part of a batch process) between the insurance company, pharmacy benefit manager (or any healthcare provider) and the accountholder's individual healthcare spending account (such as an HSA). The “accountholder-centric” model eliminates the need to file separate claims forms or settle accounts after pricing and adjudication. Further, the system is provider-friendly as it minimizes accounts receivables problems through integrated settlement with the insurance companies. Moreover, the integrated banking and investment components of the system provide accountholders with a seamless account.

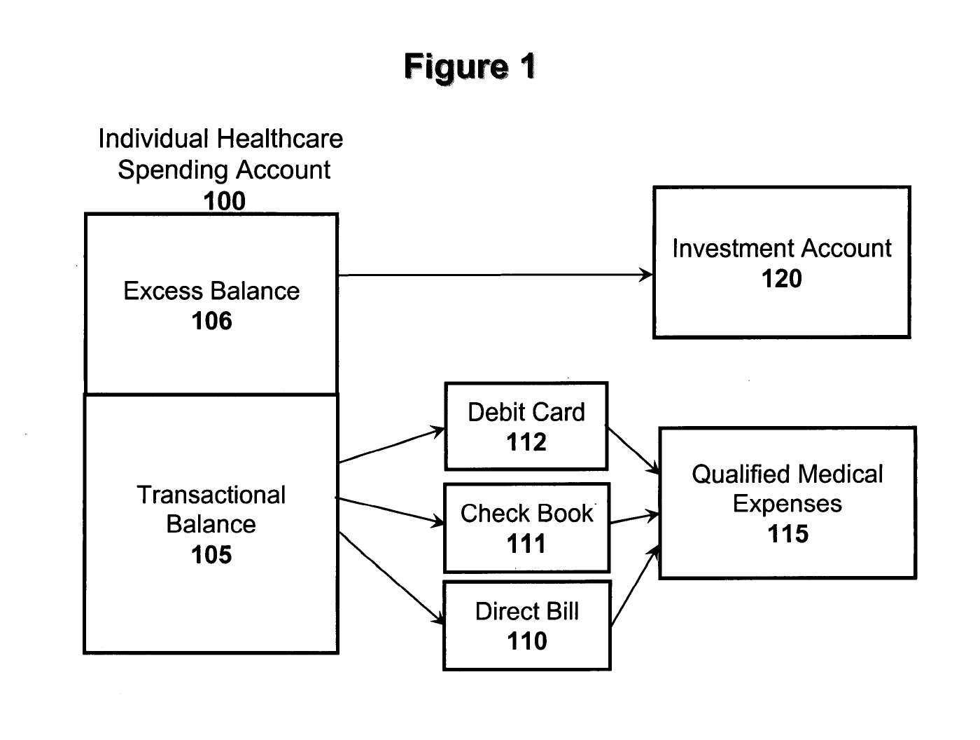

FIG. 1 shows a high level diagram of an integrated health savings account system according to the present invention. The system of FIG. 1 comprises a funded individual healthcare spending account 100 which includes both a transactional balance 105 and excess balance 106. Generally, the transactional balance 105 represents funds which are to be used for qualified medical expenses 115, and the excess balance 106 is not needed for this purpose. In a preferred embodiment, the transactional balance 105 can be accessed to pay for qualified medical expenses 115 in a variety of formats, including, but not limited to, via direct bill 110, via a check book 111, or through the use of a debit card 112.

As a preferred optional feature, the present system includes the ability to use the excess balance 106 in an investment account 120, such as mutual funds. As briefly described above, there may be a minimum amount required within the individual healthcare spending account before the use of an investment account is permitted. For example, the participant may need to keep $2,000 in the health savings account before investing in mutual funds 120, and there may also be a minimum amount required to be held in each mutual fund (e.g., $2,500).

The Individual Healthcare Spending Account Generally

The preferred individual healthcare spending account (e.g., an HSA) is interest-bearing and FDIC insured. Deposits to the account may be made by employers, by the individual employees themselves or by other persons on behalf of the individual accountholders. As described above, the withdrawal options from the individual healthcare spending account preferably include electronic transactions from insurance companies (direct bill for medical claims), pharmacy benefits managers (direct bill for pharmacy) or any other healthcare provider, as well as by debit cards and/or checks. The accountholder receives monthly account statements and the requisite IRS forms, and the account custodian/trustee maintains and monitors web and phone-based customer service, if any.

The account custodian or trustee, such as a bank, preferably facilitates many accountholder interactions with the insurance company, employer and plan administrator. For example, the custodian/trustee may facilitate enrollment, funding of the account, and payment for services (either directly to the provider or through the healthcare claims administrator) rendered through all available electronic formats. The custodian/trustee may also process deposits and withdrawals, as well as provide account statements and IRS forms to the accountholder.

The above discussion detailed the general use and setup of an integrated health savings account system with investment options. Specific functionality will now be set forth for the major tasks undertaken by the account custodian or trustee. In the following discussion, an HSA will be used as a specific exemplary type of individual healthcare spending account, but the discussion is not limited to just these specific accounts as will be understood by those of skill in the art. Further, the administrator of the account will be labeled an “HSA custodian,” but can be a custodian, trustee or other entity as understood by those skilled in the relevant art.

Enrollment

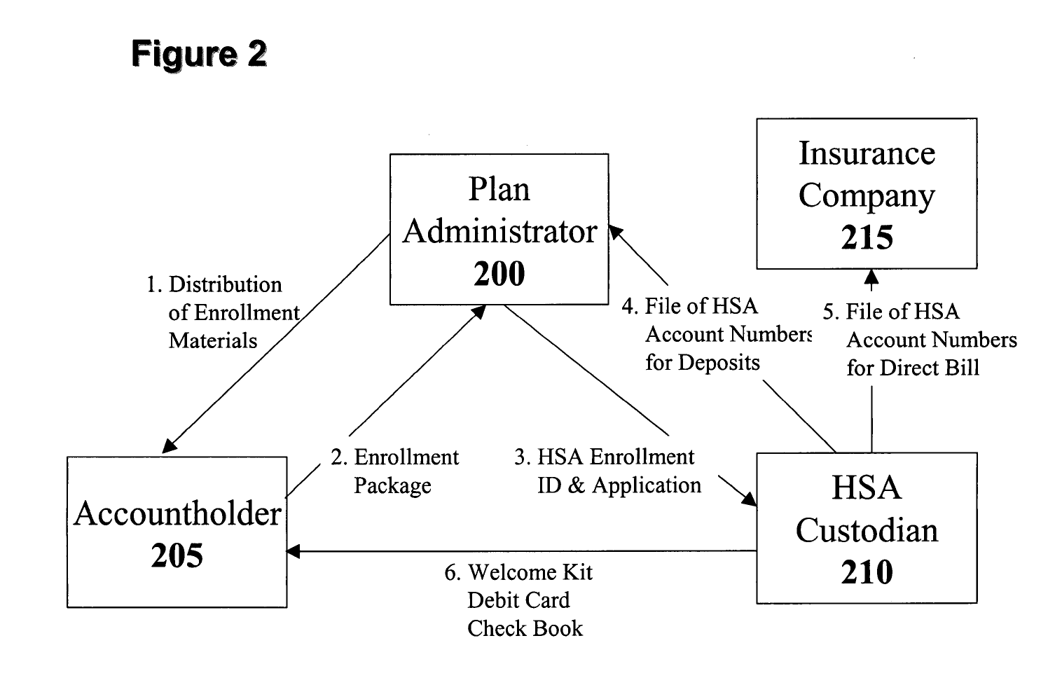

FIG. 2 is a flow chart showing a preferred enrollment process for an integrated health savings account system. To begin the enrollment process, enrollment materials are distributed from the plan administrator 200 to accountholder 205 that may participate in the integrated health savings account system. The accountholder 205 may complete the enrollment package and return it to the plan administrator 200. The plan administrator 200 forwards an HSA enrollment identification (ID) and application to the HSA custodian 210. The HSA custodian 210 establishes the health savings account and returns a file of HSA account numbers for deposits to the plan administrator 200. At the same time, the HSA custodian 210 sends a file of HSA account numbers for direct billing to the appropriate insurance company 215 utilized by the accountholder 205. The HSA custodian 210 also sends a “welcome kit”, debit card and checkbook to the accountholder 205 so that the accountholder may begin to utilize the HSA. In this way, the account has been established, and the major parties involved in deposit and billing have been notified.

It should be noted here that most of the above transactions are preferably carried out on computer systems. For example, the plan administrator 200, the HSA custodian 210 and the insurance company 215 may all have multipurpose computer systems that are used to process and facilitate various tasks associated with the administration of an HSA. Preferably, these computers are all interconnected with each other by some real-time or batched electronic communications process. For example, the accountholder 205 may be able to access statistics and information about his account via the World Wide Web (WWW), and the plan administrator 200, the HSA custodian 210 and the insurance company 215 may all communicate by some industry standard electronic format as is well known in the art.

Funding of the HSA

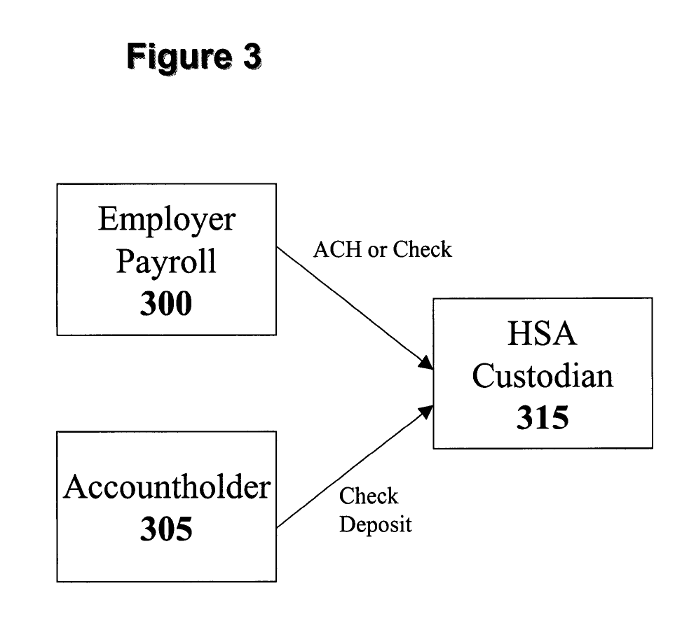

Once established, the HSA may be funded in a variety of different ways. FIG. 3 shows the major ways in which an HSA may be funded. For example, money may be automatically deducted from the employer payroll 300 in pre-selected amounts. This money is then transmitted to the HSA custodian 315 (and into the HSA) via an ACH, check or other transaction. Alternatively, the accountholder 305 may choose to add additional amounts to his/her HSA 315 via a check deposit. Other common electronic formats may also be used to add funds to an HSA and funds may be added by third parties on behalf of the accountholder.

Medical Claims Workflow

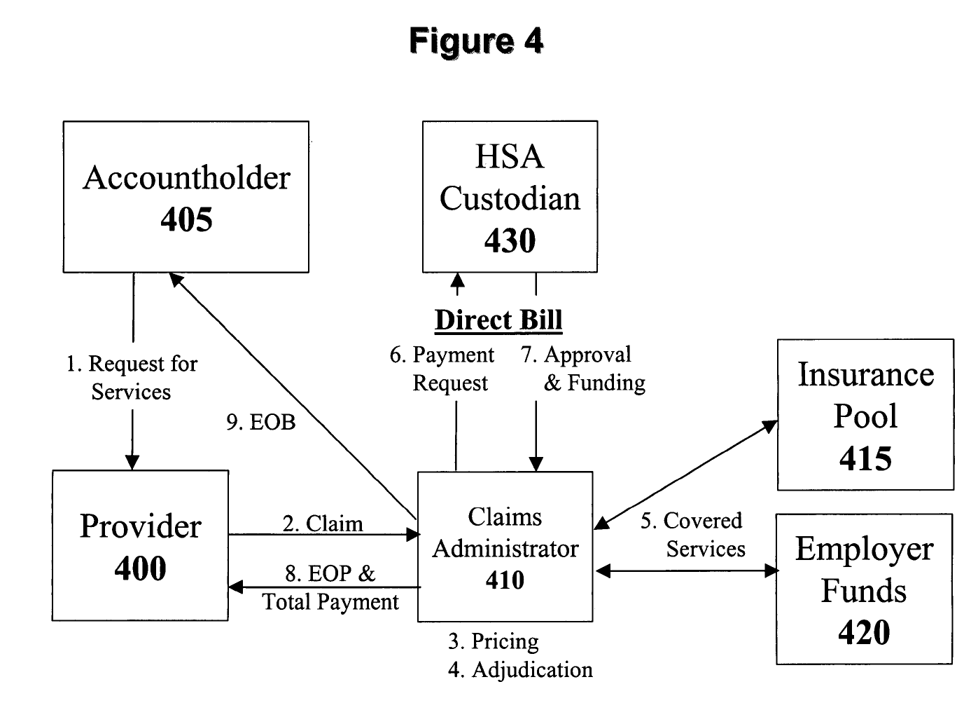

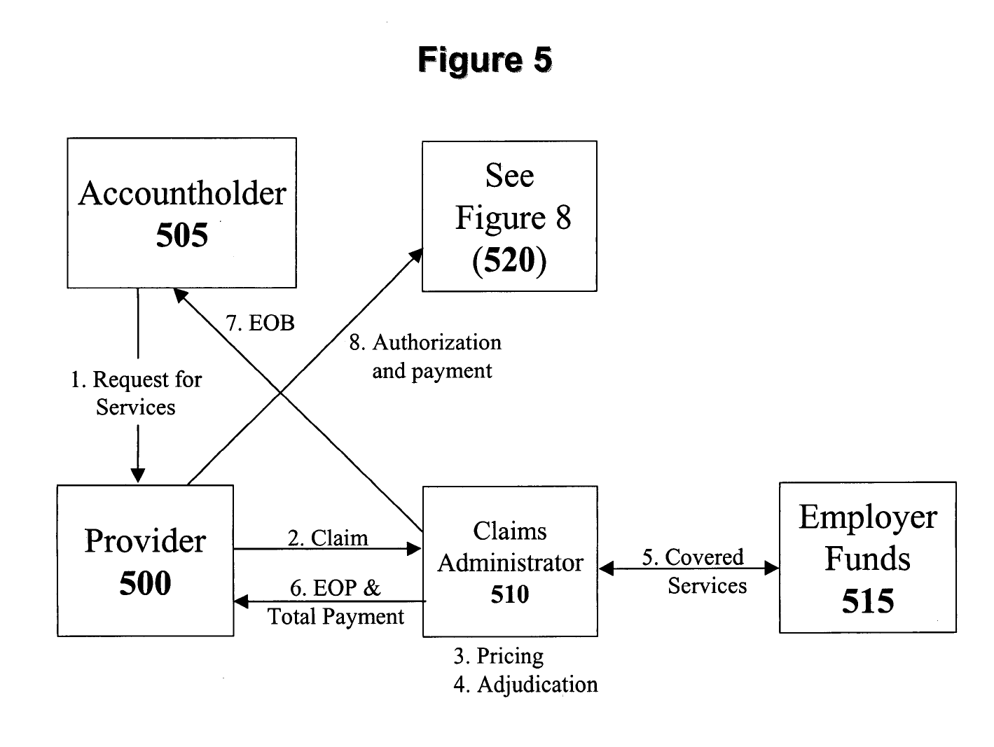

As briefly described above, medical claims may be satisfied through either the use of a direct bill process or through the use of a debit card. FIG. 4 is a flow chart of an exemplary medical claims workflow using direct billing, and FIG. 5 is a flow chart of an exemplary medical claims workflow using a debit card tied to the individual's HSA. In either case, the invention facilitates the direct access of an individual's HSA by the insurance company's claims processing computers.

The medical claims workflow using direct billing (FIG. 4) begins when the accountholder 405 requests a service from a provider 400 (a doctor, hospital or similar medical personnel). The accountholder 405 typically presents his/her insurance identification card (for eligibility determination).

After a service is rendered, a claim is sent from the provider 400 to a health plan claims administrator 410 (e.g., the health plan or insurance company). The claims administrator 410 (which may be an insurance company), typically determines the appropriate pricing and adjudicates the claim. The claim adjudication process includes determining whether and how much to pay on the submitted claim, as well as calculating and tracking any applicable accountholder deductible according to plan guidelines. After adjudication, if approved, the health plan claims administrator 410 transacts with an insurance pool 415 and/or employer funds 420 in an amount equal to the covered services represented in the adjudicated claim.

At this point in the process, the present invention's integration of the health plan claims processing system and the accountholder's HSA is fully utilized. Specifically, the health plan claims administrator 410 sends an electronic (preferably real-time, but optionally as part of a batch process) request to the HSA custodian 430 (such as a bank) related to an accountholder's healthcare claim. Specifically, this electronic request may inquire whether the individual's HSA has sufficient funds to cover the proposed claim or the request may actually request that the individual's HSA be debited to pay the accountholder's liability for the claim. The HSA custodian 430 determines whether sufficient funds exist in the individual's account and then sends approval/denial and/or funding (either partial or full) back to the health plan claims administrator 410 (or payment may be made directly to the provider) according to the amount of funds left in the accountholder's HSA.

Typically, the indication of whether an individual's HSA has sufficient funds to cover a proposed claim is communicated in real-time to the claims processing computer, and the actual funds transfer takes place as part of a batch process that occurs overnight, once a day. However, any of these information or payment transfers may take place in real-time or as part of a batch process, depending on the structure of the system. Upon receipt, the health plan claims administrator 410 preferably sends an Explanation of Payment (EOP) and the total payment back to the provider 400 in full satisfaction of the previously filed claim. Alternatively, as described above, the HSA custodian 430 may pay the provider 400 directly, skipping the claims administrator 410 as the middle man. The health plan claims administrator 410 also sends an explanation of benefits (EOB) to the accountholder 405.

FIG. 5 shows a similar process of a medical claims workflow utilizing a debit card. The debit card medical claims workflow begins when an accountholder 505 requests a service from a provider 500. After a service is provided, a claim is sent from the provider 500 to a claims administrator 510. The claims administrator 510 (which may be an insurance company), typically determines the appropriate pricing and adjudicates the claim (determines whether and how much to pay). After adjudication, if approved, the claims administrator 510 transacts with an insurance pool and/or employer funds 515 in an amount equal to the adjudicated claim for covered services.

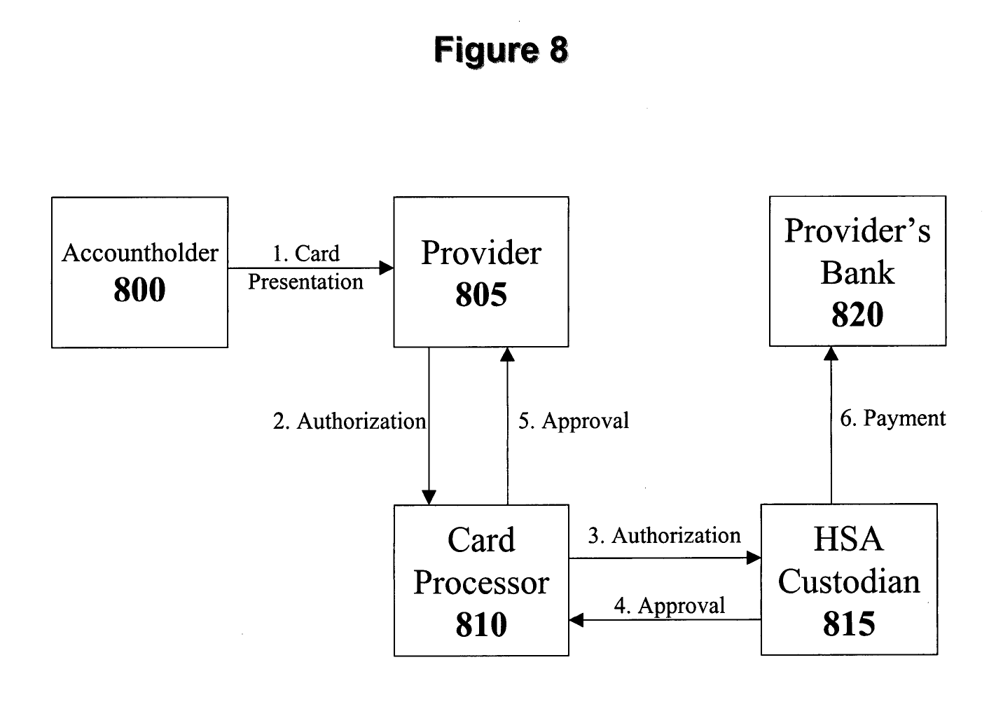

The claims administrator 510 then sends an EOP and partial payment to the provider 500. At the same time, the claims administrator sends an EOB to the accountholder 505. After receiving the EOP and partial payment, the provider 500 then sends authorization and requests payment for the claim via the debit card workflow 520 which is shown in more detail in FIG. 8.

In FIG. 8, the debit card workflow begins with an accountholder 800 presenting his/her debit card (which is tied to an HSA account) to a provider 805 when services are performed by the provider 805. A request for authorization for the claim is sent from the provider 805 to a card processor 810. The card processor 810 then sends an authorization request to the HSA custodian 815. If approved, the HSA custodian 815 sends an approval to the card processor 810 which then forwards the approval notification to the provider 805. At the same time, the HSA custodian 815 sends a payment to the provider's bank 820, in satisfaction of the provider's claim.

More generally, the present invention provides an integrated payment solution for direct billing utilizing an electronic connection (either real-time or batch) between a health plan's claims system and the debit card processor of an HSA custodian. When deciding whether to pay a claim with HSA funds, a transaction can be sent from the health plan to the debit card processor to determine (within seconds, if desired) if funds are available in the accountholder's HSA. If funds are available, a health plan claims administrator can approve and initiate provider payment. In a particularly preferred embodiment, a real-time link is established between the health plan and the debit card processor. In effect, the claims processing system appears as a point-of-sale (POS) transaction to the debit card processor.

Prescription Drugs Workflow

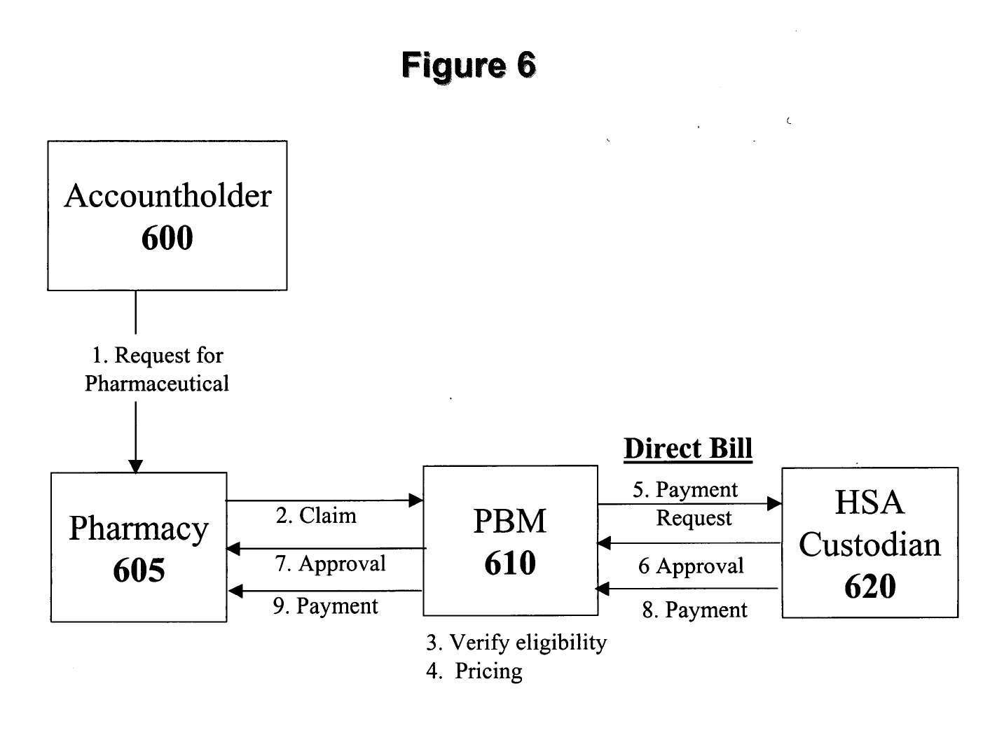

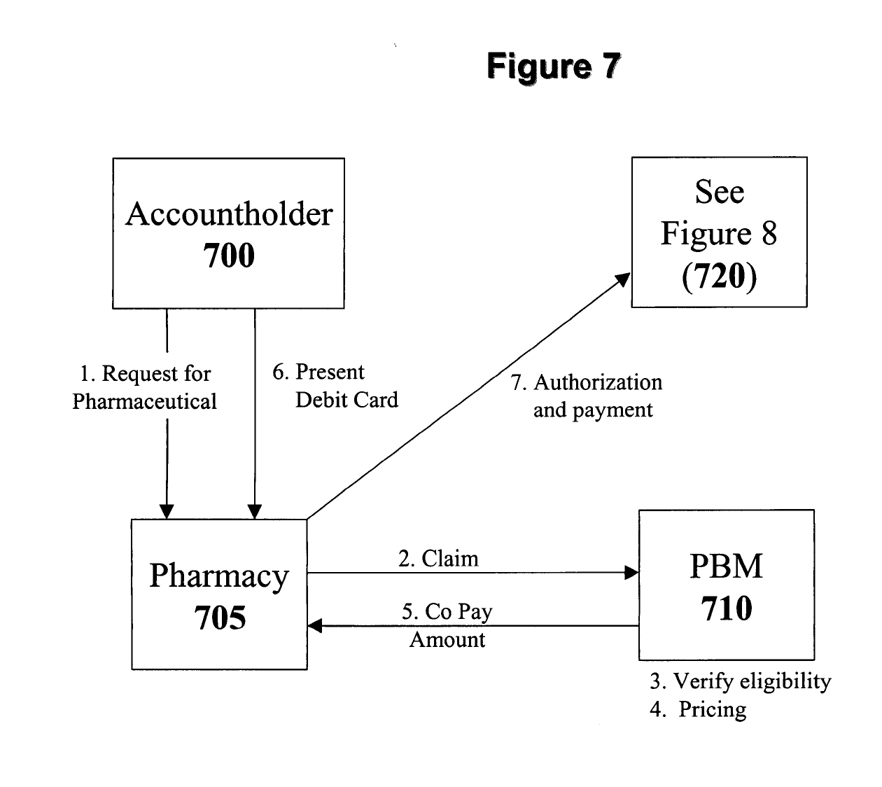

As briefly described above, prescription drugs may also be satisfied through either the use of a direct bill process or through the use of a debit card. FIG. 6 is a flow chart of an exemplary prescription drugs workflow using direct billing, and FIG. 7 is a flow chart of an exemplary prescription drugs workflow using a debit card tied to the individual's HSA.

The direct bill prescription drug workflow of FIG. 6 begins with the accountholder (individual) 600 requesting a pharmaceutical from a pharmacy 605. The pharmacy then creates and submits a claim for the prescription drug to the pharmacy benefits manager (PBM) 610. The PBM 610 processes the claim by confirming the eligibility of the accountholder (600) and pricing the requested prescription drugs. After pricing and eligibility, the PBM 610 sends a payment request to the HSA custodian 620 which determines whether there are sufficient funds in the individual's account to cover the requested payment. If the HSA custodian 620 approves the payment request, notification of this approval and payment from the HSA are sent from the HSA custodian 620 to the PBM 610. The PBM 610 then forwards this notification and payment on to the pharmacy 605 to complete the payment process.

As described above with respect to the medical claims examples, the requests for payment (or whether sufficient funds to cover a claim are available) may be sent to the HSA custodian in real-time or as part of a batch process. Preferably, the HSA custodian determines whether sufficient funds exist and notifies the PBM in real-time, but this too could be part of a batch process that occurs at a later time. Finally, the payment itself, either partial or full depending on the amount of available funds, may take place in real-time or as part of a batch process, and may be sent directly to the pharmacy, or may be sent to the pharmacy through the pharmacy benefit manager.

FIG. 7 details a similar prescription drugs workflow in the case where payment is made using a debit card tied to the HSA. The debit card prescription drugs workflow of FIG. 7 begins with an accountholder 700 requesting a prescription drug or pharmaceutical from a pharmacy 705. The pharmacy 705 then prepares a claim for the drugs and forwards the claim on to a pharmacy benefits manager (PBM) 710 for adjudication. The PBM 710 processes the claim by confirming the eligibility of the accountholder (700) and pricing the requested prescription drugs.

After eligibility and pricing are confirmed/determined, a notification of the amount due is sent to the pharmacy 705 and the accountholder 700 presents the debit card to the pharmacy 705 for payment from his/her HSA. The pharmacy 705 then sends a request for authorization and payment according to the debit card workflow of FIG. 8. The debit card workflow of FIG. 8 described above with respect to a medical claim works in an identical fashion for the pharmaceutical or prescription drug claim.

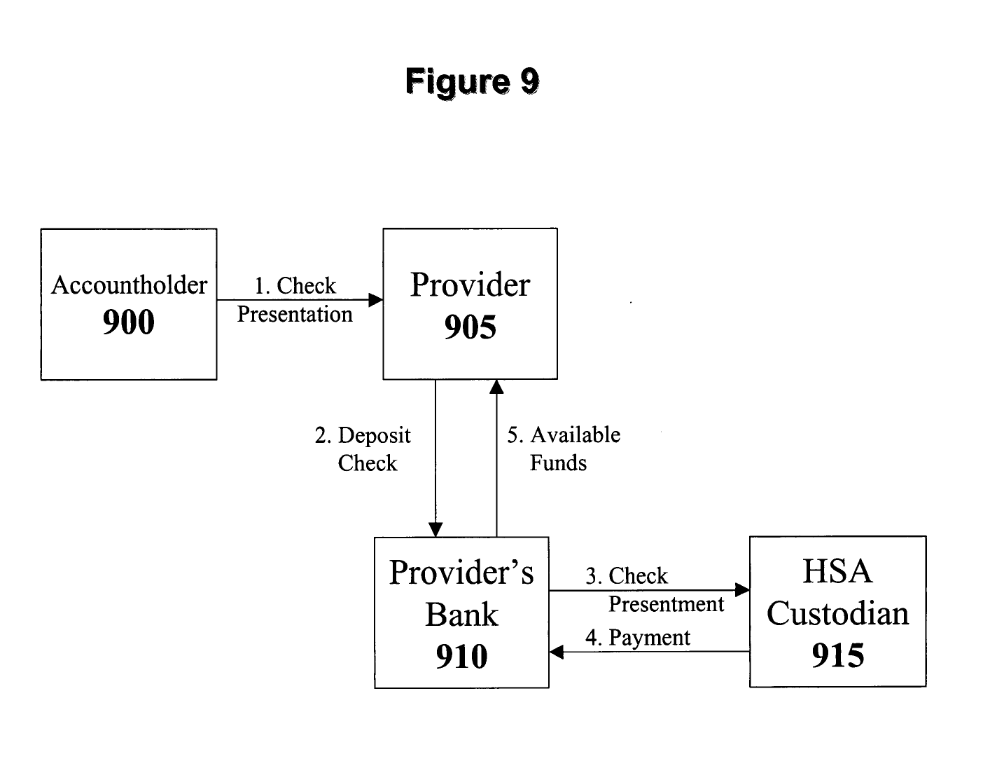

In a similar manner to the above payment methods, the HSA may also have check writing capabilities. FIG. 9 details the workflow when payment is made by check which may be used in place of the debit card workflow detailed in FIG. 8. The check workflow of FIG. 9 begins with an accountholder 900 presenting a check to a provider 905 to pay for services rendered. The provider 905 deposits the check in the provider's bank 910 which presents the check to the HSA custodian 915. If sufficient funds exist in the HSA to cover the claim for qualified medical expenses, the HSA custodian 915 then sends payment from the accountholder's HSA to the provider's bank 910, and the provider's bank 910 notifies the provider 905 that the deposited funds are available for use.

Investment Options

As briefly discussed above, in addition to the flexibility in terms of depositing funds into and withdrawing funds out of the HSA (or other individual healthcare spending account), the system and methods of the present invention are also characterized by the ability to allow accountholders to utilize various investment options as part of their HSA (see generally FIG. 1). In one preferred embodiment of the present invention, the accountholder has the opportunity to invest in a family of mutual funds including fixed income and equity funds (120 of FIG. 1). Although there are many variations of investment options, the following discussion reveals several of the most common features and limitations on the investment portion of an HSA.

For example, funds may typically be transferred between the HSA transactional account and the investment account via automated clearinghouse (ACH) transactions. This common electronic funds format maintains optimum flexibility. Also, the mutual fund balances are preferably not available for direct withdrawal by the accountholder. Instead, the funds must be moved from the investment account back into the transactional side of the HSA before withdrawal by the accountholder. Moreover, as stated above, the use of the investment account aspect of the HSA typically comes with a minimum investment and minimum incremental investment for future contributions. It is preferred if the HSA custodian also offers and supports the investment account too.

System Architecture

The integrated health savings account system described above may be implemented in a variety of different ways utilizing a variety of different computer platforms and technologies. Importantly, there must be some interconnection between the health plan claims administrator (and/or the pharmacy benefits manager or other healthcare provider) and the custodian of the individual healthcare spending account (such as an HSA). This integration provides the basis for real-time or batched access to the funded account.

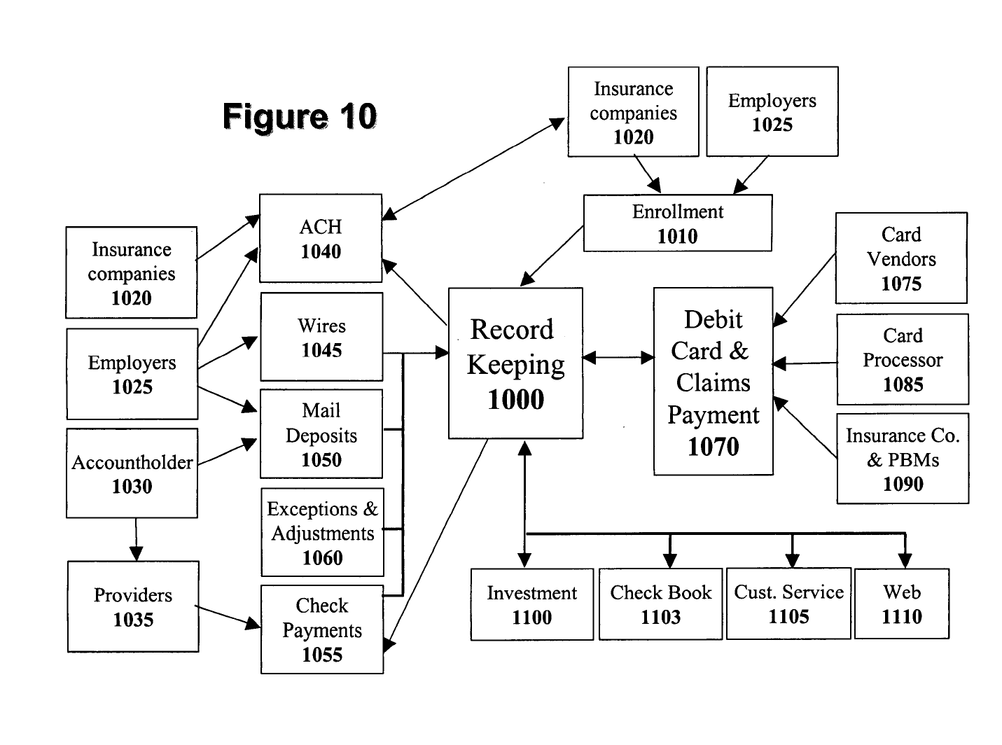

Although not intended to limit the scope of the present application, FIG. 10 is a high level block diagram of system flow for an exemplary integrated health savings account system. Specifically, FIG. 10 details an exemplary manner in which the various functionalities of the present invention may be split among different entities.

In FIG. 10, an integrated health savings account system includes primary record-keeping subsystem 1000 at the heart of many of the system and subsystem interactions. The record-keeping system is preferably electronically interconnected with an enrollment and reporting database 1010. This database 1010 stores enrollment data sent from various health plans that interact with the integrated system. Preferably, the enrollment and reporting database 1010 interfaces daily with the recordkeeping system 1000. Preferably, at least insurance companies (health plan administrators) 1020 and employers 1025 also interface with the enrollment database 1010.

The integrated health savings account system preferably interconnects insurance companies 1020, employers 1025, accountholders 1030 and providers 1035 by some electronic or other communications media to enable deposits/withdrawals into and out of the individual healthcare spending accounts administered within the integrated system. For example, FIG. 10 shows that ACH 1040, wires 1045, and mail deposits 1050 may be used to deposit funds, and the integrated system also included functionality to make payments to providers by check 1055 and to keep track of exceptions and adjustments 1060.

The main record-keeping subsystem 1000 also preferably interconnects with a debit card and claims payment subsystem 1070 to aid in the processing of debit card and real-time clams transactions. The debit card and claims payment subsystem 1070 may also be accessed by, for example, card vendors 1075, card processors 1080 and/or insurance companies and PBMs 1090. These entities work in tandem to provide debit card functionality and processing to the integrated health savings account system, as well as to process adjudicated claims on a real time basis.

Finally, additional services such as investment management 1100, check book vendors 1103, customer service 1105 and web functionality 1110 may also be connected to the main system 1000. Although these selected subsystems and their associated interconnections have been provided as preferred, there is an almost limitless variety of ways in which these and other subsystems could be interconnected and implemented, and those shown in FIG. 10 are not intended to limit the scope of the present invention in any way.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

1-25. (canceled)

26. A method for providing a point-of-sales solution for an integrated health savings account, the method comprising:
funding an individual healthcare spending account owned by a first accountholder;
receiving, by a computer processor via a first electronic link, from a health plan claims administrator, a request to determine whether an amount of funds available in the individual healthcare spending account is sufficient to cover an amount of an adjudicated healthcare claim and a request for payment of the claim related to the first accountholder, wherein the first electronic link is between the individual healthcare spending account and the health plan claims administrator;
processing the request as a remote point-of-sales terminal, wherein the processing further comprises:
determining, by the computer processor, whether the amount of funds available in the individual healthcare spending account is sufficient to cover the amount of the adjudicated healthcare claim;
communicating, by the computer processor via the first electronic link, at least an indication of whether the amount of funds available in the individual healthcare spending account is sufficient to cover the amount of the adjudicated healthcare claim to the health plan claims administrator, wherein the indication comprises approval or denial of the request; and
withdrawing a payment in the amount of the healthcare claim from the individual healthcare spending account when the request includes the request for payment of the claim.

27. The method of claim 26, further comprising:
transferring, by the computer processor via a second electronic link, as a withdrawal, an amount of any excess funds in the individual healthcare spending account after deducting the amount of the adjudicated healthcare claim to fund an investment account, wherein the second electronic link is between the individual healthcare spending account and the health plan claims administrator; and
moving investment account withdrawals from the investment account and depositing the investment account withdrawals in the healthcare spending account as required to maintain a minimum balance in the healthcare spending account such that the investment account withdrawals are deposited only into the individual healthcare spending account, wherein the investment account withdrawals are used by the remote point-of-sales terminal to process future requests from the health plan claims administrator.

28. The method of claim 26, wherein the received requests are based on the first account holder providing a debit card associated with the healthcare spending account to pay a provider for health services.

29. The method of claim 26, wherein the request is received from the claims administrator via the first electronic link as part of a real-time electronic process.

30. The method of claim 26, wherein the request is received from the claims administrator via the first electronic link as part of an electronic batch process.

31. The method of claim 26, wherein the communication of the indication is sent to the claims administrator via the first electronic link as part of a real-time electronic process.

32. The method of claim 26, wherein the communication of the indication is sent to the claims administrator via the first electronic link as part of an electronic batch process.

33. The method of claim 26, wherein the individual healthcare spending account is a Health Savings Account (HSA).

34. The method of claim 26, wherein the payment related to the adjudicated healthcare claim from the individual healthcare spending account is sent to a provider directly by the computer processor.

35. The method of claim 26, wherein the payment related to the adjudicated healthcare claim from the individual healthcare spending account to the claims administrator is sent directly by the computer processor.

36. The method of claim 26, wherein the payment related to the adjudicated healthcare claim from the individual healthcare spending account is sent to a provider through the claims administrator directly by the computer processor.

37. The method of claim 36, wherein the payment is a partial payment of the adjudicated claim in an amount equal to the amount of funds available in the individual healthcare spending account.

38. The method of claim 26, wherein the adjudicated healthcare claim has been adjudicated for amount of benefits, amount of deductible, and eligibility based on the presentment of an identification card by the accountholder to a provider.

39. The method of claim 26, wherein the claims administrator is a pharmacy benefits manager (PBM) and the healthcare claim is a request for prescription drugs.

40. The method of claim 26, wherein the step of funding the individual healthcare spending account is accomplished via Automated Clearinghouse (ACH) transaction, wire or check deposit.

41. A method for providing a point-of-sales solution for an integrated health savings account, the method comprising:
funding an individual healthcare spending account owned by a first accountholder;
receiving from a health plan claims administrator, a request to determine whether an amount of funds available in the individual healthcare spending account is sufficient to cover an amount of an adjudicated healthcare claim and a request for payment of the claim related to the first accountholder, wherein the received requests are generated based on the first account holder providing a debit card associated with the healthcare spending account to pay for health services from a provider;
processing the request as a debit card remote point-of-sales terminal, wherein the processing further comprises:
determining, by the computer processor, whether the amount of funds available in the individual healthcare spending account is sufficient to cover the amount of the adjudicated healthcare claim;
communicating, by the computer processor via the first electronic link, at least an indication of whether the amount of funds available in the individual healthcare spending account is sufficient to cover the amount of the adjudicated healthcare claim to the health plan claims administrator, wherein the indication comprises approval or denial of the request;
withdrawing a payment in the amount of the healthcare claim from the individual healthcare spending account when the request includes the request for payment of the claim.
transferring as a withdrawal, an amount of any excess funds in the individual healthcare spending account after deducting the amount of the adjudicated healthcare claim to fund an investment account; and
moving investment account withdrawals from the investment account and depositing the investment account withdrawals in the healthcare spending account as required to maintain a minimum balance in the healthcare spending account such that the investment account withdrawals are deposited only into the individual healthcare spending account, wherein the investment account withdrawals are used by the debit card remote point-of-sales terminal to process future requests from the health plan claims administrator.

42. A system for providing a point-of-sales solution for an integrated health savings account, the method comprising:
a server comprising remote point-of-sales terminal functionality for a debit card associated with a funded individual healthcare spending account owned by a first accountholder, the server being configured to:
receive from a health plan claims administrator, a request to determine whether an amount of funds available in the individual healthcare spending account is sufficient to cover an amount of an adjudicated healthcare claim and a request for payment of the claim related to the first accountholder, wherein the received requests are generated based on the first account holder providing a debit card associated with the healthcare spending account to pay for health services from a provider;
determine whether the amount of funds available in the individual healthcare spending account is sufficient to cover the amount of the adjudicated healthcare claim;
communicate at least an indication of whether the amount of funds available in the individual healthcare spending account is sufficient to cover the amount of the adjudicated healthcare claim to the health plan claims administrator, wherein the indication comprises approval or denial of the request;
withdraw a payment in the amount of the healthcare claim from the individual healthcare spending account when the request includes the request for payment of the claim.
transfer as a withdrawal, an amount of any excess funds in the individual healthcare spending account after deducting the amount of the adjudicated healthcare claim to fund an investment account; and
move investment account withdrawals from the investment account and depositing the investment account withdrawals in the healthcare spending account as required to maintain a minimum balance in the healthcare spending account such that the investment account withdrawals are deposited only into the individual healthcare spending account, wherein the investment account withdrawals are used by the debit card remote point-of-sales terminal to process future requests from the health plan claims administrator.
